(19) United States
(12) Patent Application Publication
(10) Pub. No.: US 2007/0092859 A1
(43) Pub. Date: Apr. 26, 2007

(54) Award based learning

(76) Inventors: Stanley J. Watts, Bayonne, NJ (US); Berj Andrew Akian, Hoboken, NJ (US)

Correspondence Address: ASHOK TANKHA;OF COUNSEL, LIPTON, WEINBERGER & HUSICK, 36 GREENLEIGH DRIVE, SEWELL, NJ, 08080, US

(21) Appl. No.: 11/259,226

(22) Filed: Oct. 25, 2005

(51) Int. Cl. G09B 3/00

(52) U.S. Cl. 434/322

(57) ABSTRACT

The inventive concept disclosed herein provides an award based system for users to create and upload educational material on the award based learning website, and for other users to download and preview, review, edit, critique and comment on the educational material. The method includes a server with databases to store the users, lesson plans, comments on the lesson plans, award data, items that a user can redeem against their accrued points, etc. Users can log into the system from any computer that has internet access, a web browser, and proper input and display devices. Users receive award points for performing certain activities related to the educational material on the website. These activities include obtaining unique downloads, uploading new lesson plans, leaving feedback on lesson plans, logging into the system, etc. Award points accrued by a user can be redeemed for an item of value. Each item has an assigned award point value.

### BACKGROUND OF THE INVENTION

This invention relates, in general, to internet-based learning and specifically to the optimal usage of the internet for an efficient and a cost effective means of mass education. Although internet-based education is presently provided over the internet, there is an unsatisfied market need for a method that encourages users of the internet based teaching system to use educational material posted on the website. The method disclosed herein provides users with an incentive for downloading and using the educational material posted on the website by rewarding users for previewing, editing, using, rating, commenting, etc. such educational material.

### BRIEF DESCRIPTION OF THE FIGURES

FIG. 1 is a block diagram of the award based learning (ABL) system.

FIG. 2 is a diagram of the client-server relationship of the computers connected to the ABL system and the internet.

FIG. 3A is a flow chart showing the login process of a user.

FIG. 3B is a flow chart of the processes of ABL.

FIG. 4A is a flow chart showing the steps involved in editing, building and previewing lesson plans under the manage personal lesson plans option.

FIG. 4B is a flow chart showing the steps involved in uploading lesson plans and returning back to the main menu under the manage personal lesson plans option.

FIG. 5A is a flow chart showing the steps involved in searching, previewing and returning back to the main menu under browse lesson plans option.

FIG. 5B is a flow chart showing the steps involved in downloading a lesson plan from the ABL website under the browse lesson plans option.

FIG. 5C is a flow chart showing the steps involved in rating lesson plans and the points awarded for such activity under the browse lesson plans option.

FIG. 6 is a flow chart showing the steps involved in searching lesson plans and the redemption of award points for items posted on the ABL database.

FIG. 7 is a flow chart showing the steps involved in previewing the lesson plans uploaded on the ABL website, displaying various other activities performed during the session and returning back to the main menu.

### DETAILED DESCRIPTION OF THE INVENTION

The award based learning method and all its embodiments herein will be referred to as the ABL system. A user of the ABL system comprises any person who is registered on the ABL system, for example, a teacher, faculty member, administrator, student, etc. Also, herein, educational material comprises any material that is used to impart education or provide training to a user, for example, a course material, a tutorial, a lesson plan, etc. Also, herein, a lesson plan will be used as an example of an educational material that is uploaded on the ABL website by a user, and which may thereafter be downloaded by a user to preview, edit, rate, comment on, critique, etc. the lesson plan.

Herein, uploading educational material by a user on the ABL website comprises creating and posting educational material on the ABL website including editing, and managing educational material, providing feedback to users on educational material, etc. Also, herein, downloading educational material by a user comprises logging into the ABL website and thereafter downloading the educational material to preview, edit, rate, comment on, critique, etc. the educational material.

The ABL system allows users registered on the ABL system to upload educational material, for example a lesson plan, on an ABL website hosted on the internet, and for users to download the uploaded educational material posted on the ABL website to view, edit, rate, comment on, critique, etc. the uploaded educational material.

In one embodiment of the invention, when a user other than the author of the lesson plan, downloads a lesson plan, the user who uploads the lesson plan and the user who downloads the lesson plan accrue award points. In another embodiment of the invention, the user who creates and uploads a lesson plan on the ABL website accrues no points for the upload. In another embodiment of the invention, users accrue award points only once on any given day for logging into the ABL system and downloading the educational material. In another embodiment of the invention, a user, other than the user that uploaded the lesson plan, accrues award points for providing comments on the uploaded lesson plan. In yet another embodiment of the invention, if the user provides a positive feedback on the lesson plan, the user that uploaded the lesson plan receives award points. In another embodiment of the invention, the points awarded for an activity, for example, for uploading a lesson plan, may be increased to a certain number of points, or decreased to zero. If no points are awarded for an activity, award points do not accrue to the user for performing that activity.

The ABL system comprises an ABL server and at least two client computers. Herein, a client computer is a computer used by a user to log into the ABL website to upload a lesson plan, or download a lesson plan. The ABL server contains one or more databases for user information, educational materials such as lesson plan information, award information including items that can be redeemed and the points associated with the items, critique information, feedback information regarding the educational material, for example, how many times it has been downloaded, etc. Users can browse the ABL databases. The client computers have access to the internet and are equipped with the necessary software to run a web browser. Users can log into the ABL system from any client computer that has an internet access, a web browser and proper input and display devices. A user with internet access and a web browser can use ABL to create lesson plans, upload those lesson plans on the ABL website and make them available for other users to download and preview, view, rate, comment on, critique, etc.

Award points accrued by a user can be redeemed by the user for an item of value. Each item has an award point value. The items that can be redeemed in exchange for award points are posted on the ABL database.

The ABL system provides an effective medium for users to share educational material that meet state curriculum requirements. The ABL system also allows educational material such as lesson plans that receive a high rating to be distributed to or used as optional reading in other school districts.

The ABL system also assists in increasing the quality of the educational material by allowing users to download lesson plans and to provide feedback on the lesson plans which the author of the lesson plan can thereafter use to improve the quality of the lesson plan.

The ABL system also allows the user to present a lesson in a format that is most appropriate for the user for whom the lesson plan is intended. The user can choose the lesson plans to be posted on the website and the mode of teaching. Use of a computer or television may benefit students for a particular lesson, but no part of the ABL system would restrict students to one particular means of communication.

The ABL system provides an educational system at a greatly reduced cost to schools since the system uses standard hardware and software for client computers. Since the user is the only person that has an account for the server, there is no requirement that each user, for example a student, have a computer. The user only needs access to the ABL server to access the ABL website and download the lesson plan. Additionally, users can upload and download educational material from their home, provided they have a computer at home that has a web browser and internet access.

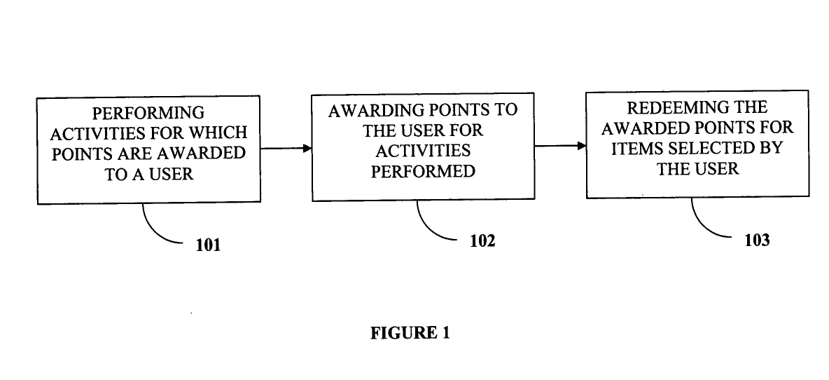

FIG. 1 is a block diagram of the award based learning (ABL) system. The ABL system allows a user uses to access the ABL website to perform various educational related activities 101 on the lesson plans posted on the website and accrue award points based on such activities. The user earns award points 102 assigned for the activity that he performs on the lesson plans. These activities comprise creating, editing, using, rating, downloading, commenting on and managing lesson plans. Award points accrued by a user can be exchanged for an item of value 103 that the user selects. The associated award points are posted on the ABL database.

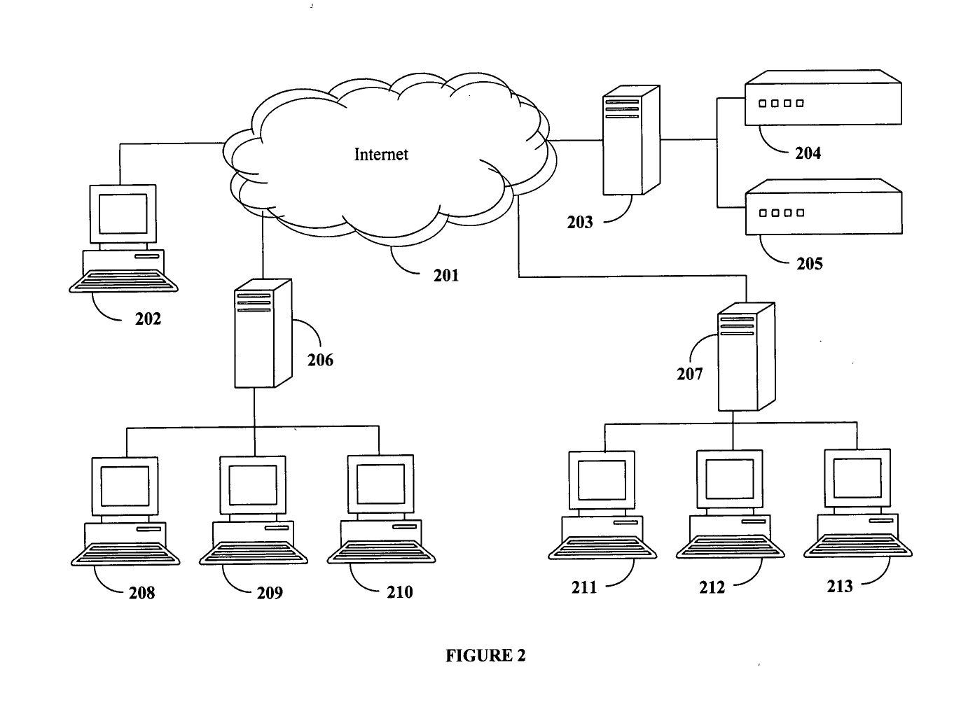

FIG. 2 is a schematic diagram of the client computer—ABL server relationship on the ABL system and the internet. The figure illustrates an embodiment of ABL wherein multiple user computers 208, 209, 210, 211, 212, 213 and 202 can access the ABL server 203, provided that each client computer has a web browser and access to the internet 201. The ABL server 203 contains one or more databases, for example databases 204, 205, etc. to store the lesson plan, user information, feedback information, award information, etc. The ABL server 203 is connected to the client computers 208, 209, 210, 211, 212, 213 and 202 through peer servers 206 and 207.

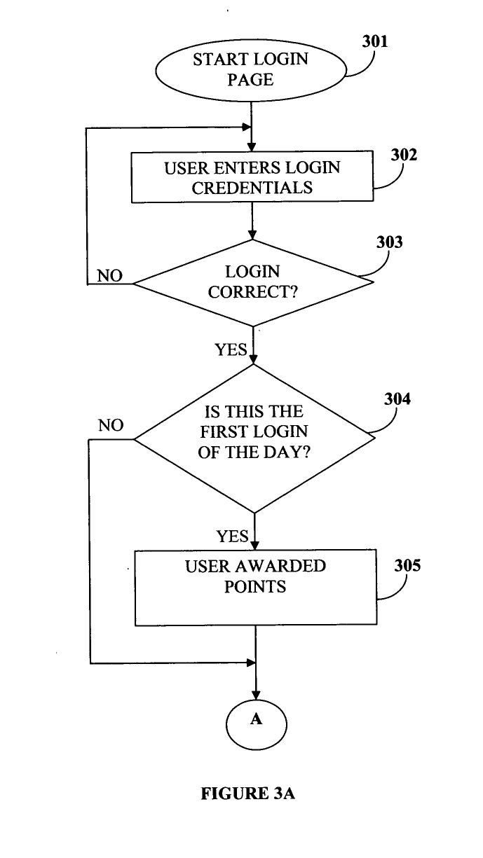

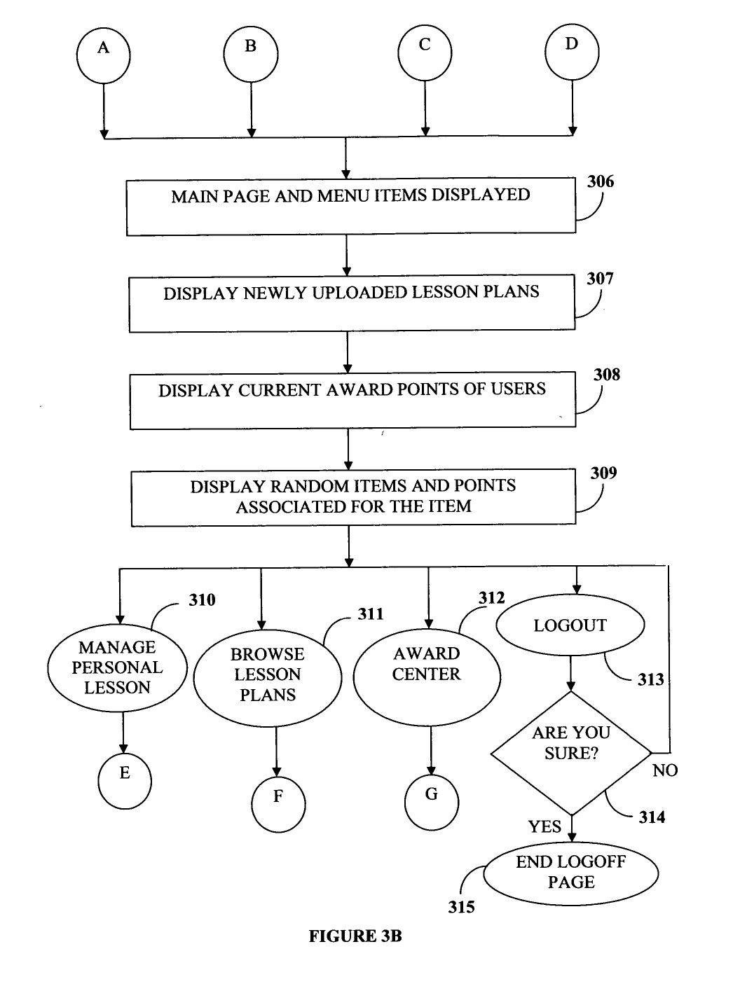

FIG. 3A is a flow chart showing the login process for a user and the main menu. The flow chart illustrates the login process 301 to 305, and the options 310 to 313 shown in FIG. 3B that a user has access to immediately upon logging in to the ABL website. In one embodiment of the invention, once the user enters the login information 302 and the information is verified 303, the user that downloads a lesson plan from the ABL website receives award points 305 if it is the user's first login of the day 304, and the user that uploaded the lesson plan also receives award points.

FIG. 3B is a flow chart showing the processes of the ABL system. Upon a successful login on the ABL website by a user, the main page menu 306 is generated. The display on the main page includes newly uploaded lesson plans 307, the user's total award points 308, point values assigned for performance of different activities on the uploaded lesson plan, and the point values associated with an item 309. When the user logs in, the database will display different items at random ranging, for example, from pencils for 10 points, to calculators for 100 points, to computers for 1000 points. When the user logs in the next time, the items displayed may be a box of crayons for 5 points, a gift certificate for $50 for 5000 points, etc. The menu presents the user with four options, namely, manage personal lesson plans 310, browse lesson plans 311, review award center 312, and log-out 313. The log-out process firsts asks the user to confirm whether the user is sure that he or she desires to log-out 314, and upon confirmation, initiates the log-off process 315.

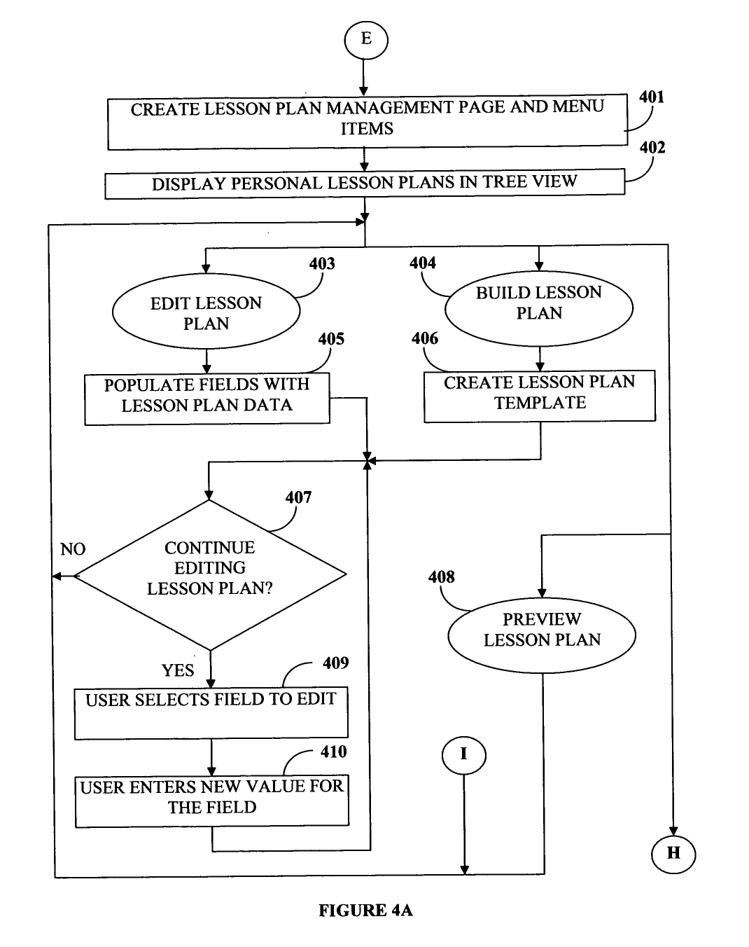

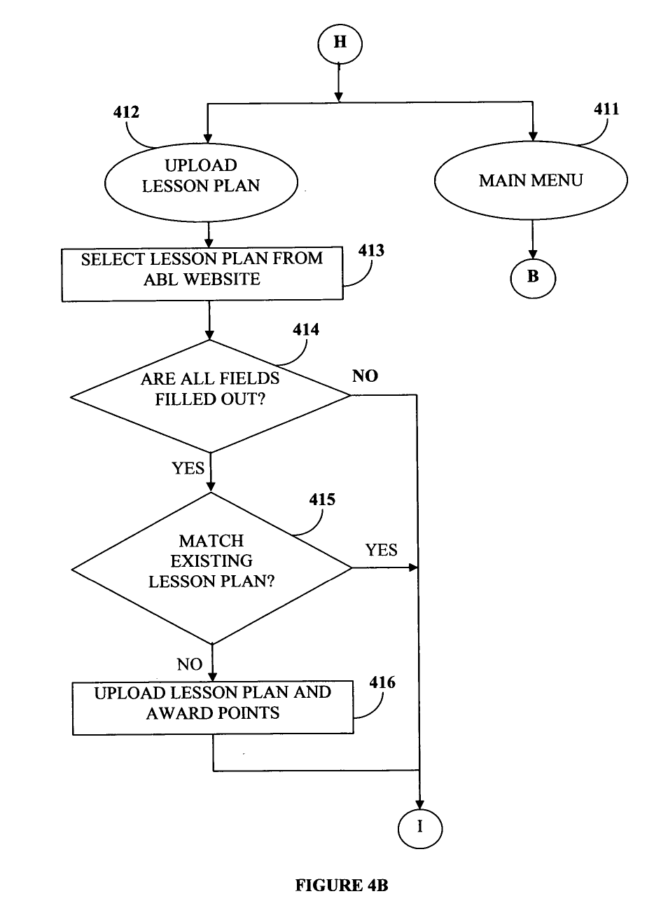

FIG. 4A is a flow chart showing the steps involved in editing, building and previewing lesson plans under the manage personal lesson plans option. When the user selects the manage personal lesson plans page 310, the corresponding menu items are loaded 401. The user's lesson plans are loaded and displayed in a tree-view format 402. The edit lesson plan option 403 populates the fields on the web page with the data from a selected lesson plan 405 and allows the user to edit those fields. Similarly, the build lesson plan option 404 allows the user to edit the same fields, but starts with the lesson plan template with blank fields that the user needs to fill out 406 instead of loading previously saved lesson plan information. A user can select the fields that are to be edited 409 and enter new values for these selected fields 410. When the user completes editing a lesson plan 407, the user is taken back to the lesson plans management menu. The preview lesson plans 408 option displays the built lesson plan, as viewed by other users.

FIG. 4B is a flow chart showing the steps involved in uploading lesson plans of a user, and returning back to the main menu under the manage personal lesson plans option. To upload a new lesson plan 412, the user selects a lesson plan 413 and fills out the fields that are required to be completed 414. Also, a lesson plan can be created and uploaded only once, i.e., an uploaded lesson plan cannot match an already existing lesson plan 415. If all the fields are filled and the lesson plan does not match an existing lesson plan, then the new lesson plan is uploaded and the user that created and uploaded the lesson plan receives award points 416. The main menu option 411 returns the user to the main menu page.

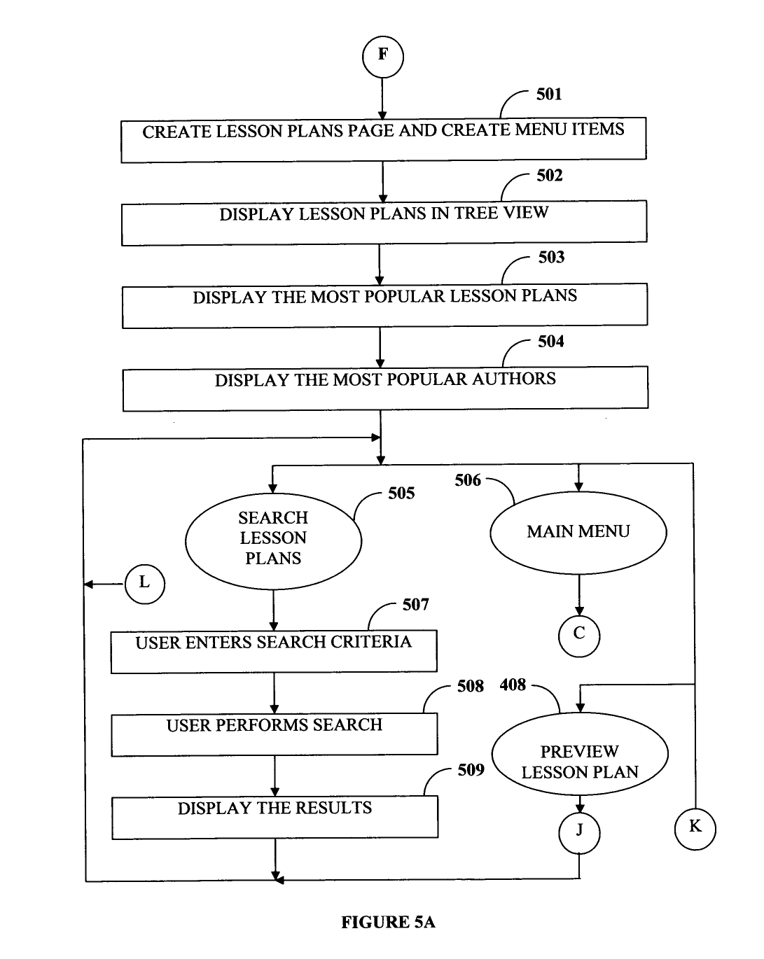

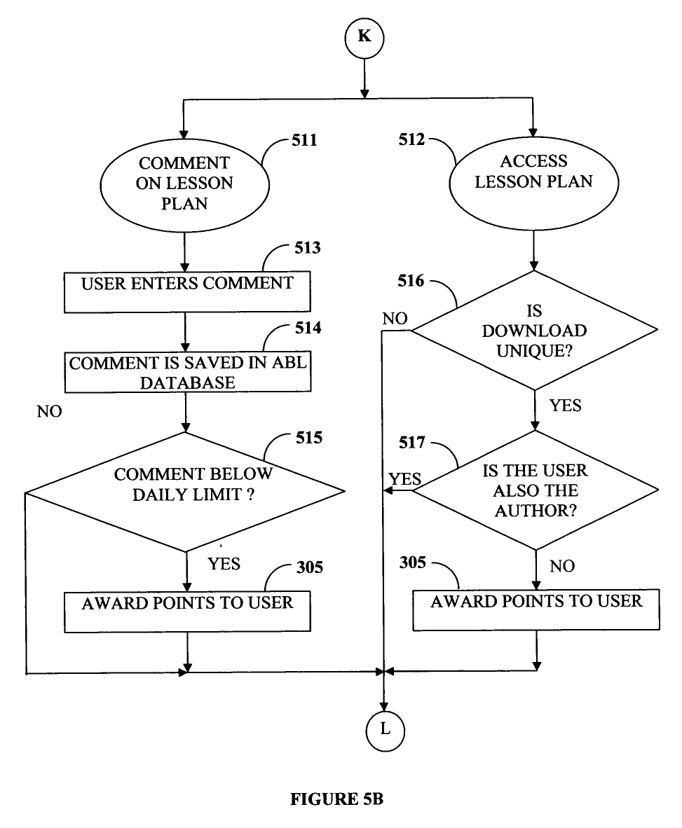

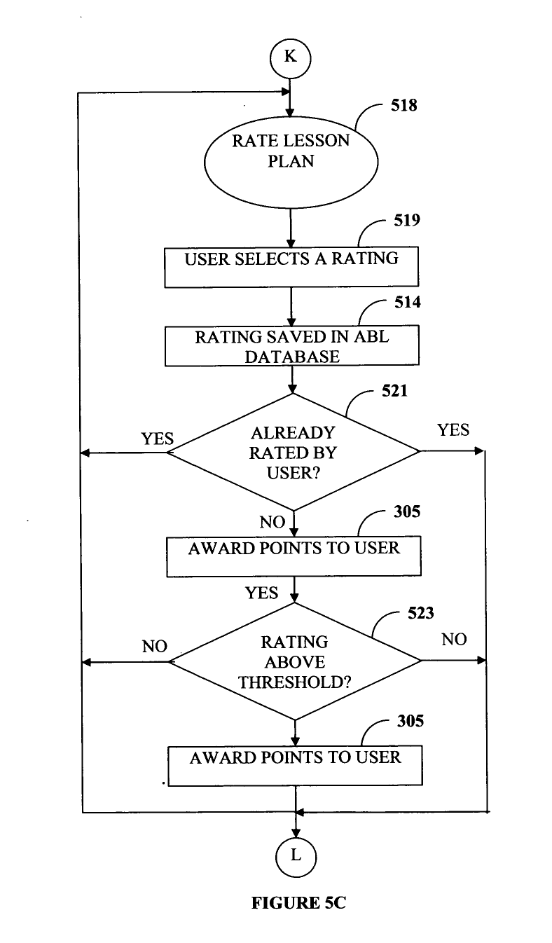

FIG. 5A is a flow chart showing the steps involved in searching, previewing and returning back to the main menu under the browse lesson plans option. The flowchart illustrates the processes that occur when the user selects the browse lesson plans option 311. The browse lesson plans page and menu items are loaded 501, and the lesson plans that users have uploaded on the ABL website are displayed in a tree-view format 502. User can access, browse, review, critique, etc. these lesson plans. The most popular lesson plans 503 and the most popular authors 504 of the lesson plans are also displayed. The preview lesson plans feature 408 behaves like a preview command.

Upon selecting the search lesson plans option 505, the user is prompted to enter the search criteria 507. A search is performed 508 by the user and the results are displayed 509 on the user's computer screen. Upon selecting the main menu option 506, the user is taken back to the main menu.

FIG. 5B is a flow chart showing the steps involved in downloading and commenting on lesson plans on the ABL website for which pre-assigned award points accrue to the user, under the browse lesson plans option. Upon selection of the option to comment on the lesson plan 511, the user is prompted to type in the comment 513. This comment is stored in the ABL database 514 and can be viewed by other users in the preview lesson plan option 408. In one embodiment of the invention, the number of points awarded to a user for providing such comments for a particular activity 515 is restricted for each day. For example, if the maximum number of points that a user can receive for commenting on a lesson plan is 100 and the number of points that accrue to a user is 5 points per comment, no points will accrue to a user for the twenty-first comment that the user provides on any given day. In another embodiment of the invention, the user can provide an unlimited number of comments per day for an activity and receive award points for each such comment below the daily point limit for an activity. The user can also download the lesson plans 512 under the browse lesson plan option. If the user who downloads the lesson plan on the ABL website is a person other than the creator of the lesson plan 517, then such a download is termed as a unique download 516 and in one embodiment of the invention the user accrues award points 305 only once on any given day for such a download.

FIG. 5C is a flow chart showing the steps involved in rating lesson plans and awarding the assigned number of points to a user for performing the above activity under the browse lesson plans option. Upon selecting the rate lesson plan option 518, the user is prompted to select a rating 519. The rating is then saved in the ABL database 514. The user is awarded the assigned award points if the most recent rating given exceeds the daily threshold. For example, if a certain lesson plan receives an average rating of 2 on a particular day, and one user rates it as 3, then such a rating is said to be above the daily threshold. This threshold rating is also displayed when a user previews a lesson plan 408. In one embodiment of the invention, the user that uploaded the lesson plan receives award points 305 if the lesson plan is ranked higher than the daily threshold 523 by other users, and in another embodiment of the invention the user that downloaded and rated the lesson plan also receives award points. In another embodiment of the invention, a user can rate a lesson plan only once 521, and such rating accrues award points 305.

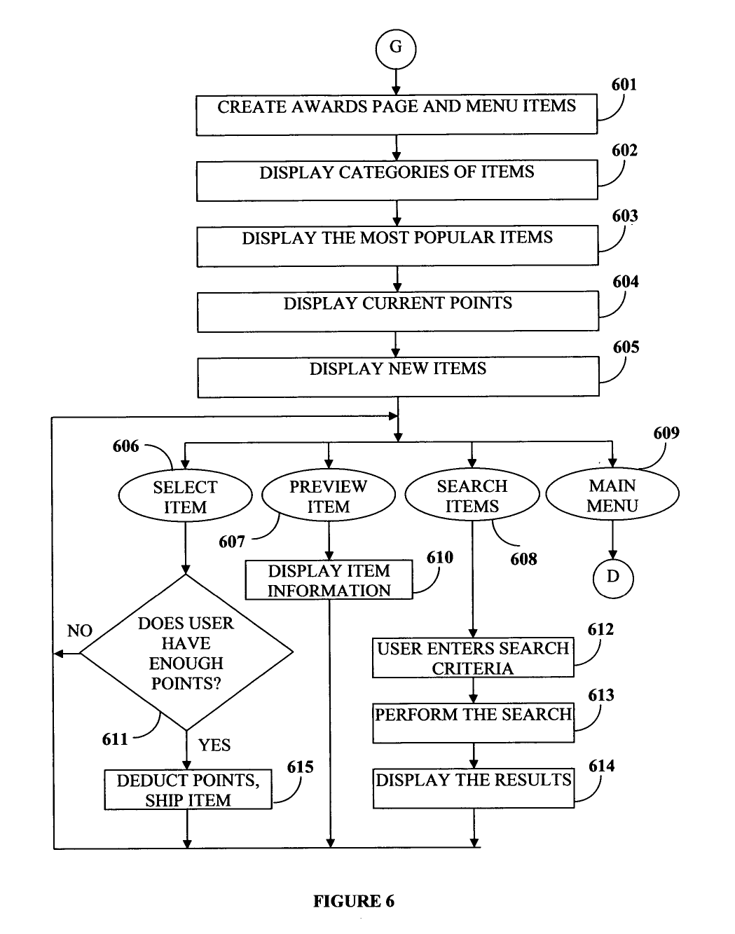

FIG. 6 is a flow chart showing the steps involved in searching lesson plans and shipping items to the user in exchange for points awarded to the user. The figure shows the processes for loading and using the award center option 312. When the user selects award center 312, the awards page and the menu items are created 601. The awards page displays the categories of items 602, the most popular items 603, the user's total award points 604, and also new items 605. The user can select an item for purchase 606 against the user's accrued award points for which he or she is prompted to confirm the order. A confirmation is obtained only if the user has a sufficient number of award points to exchange for the selected item 611. If the order is confirmed, award points are deducted from the user's total and the shipping order is processed 615. The user can preview an item 607 which displays more information on the items selected 610. The user can also choose to search for an item 608, wherein the user enters the search criteria 612 and performs a search 613 for which the results are displayed 614. The user can also return back to the main menu 609 from the awards page menu.

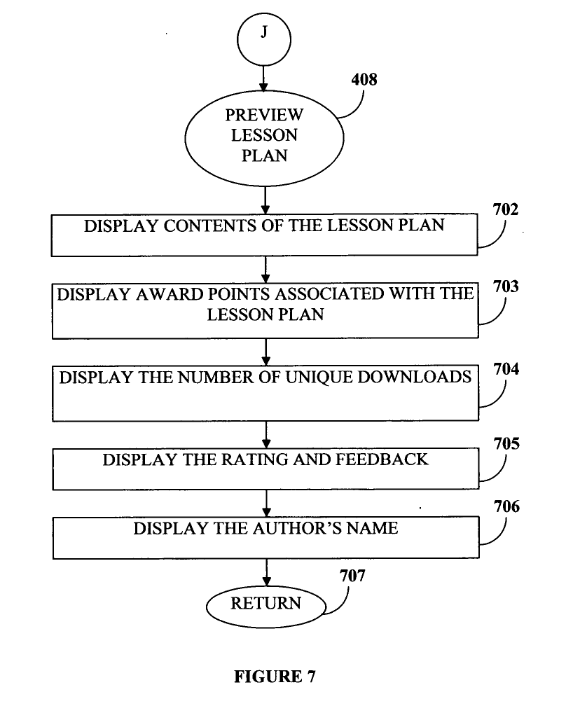

FIG. 7 is a flow chart showing the steps involved in displaying or previewing the various activities done throughout the session and for returning back to the main menu. The flowchart shows the process for displaying the preview of a lesson plan. Preview lesson plans option 408 displays the contents of a lesson plan, as viewed by any user. The displayed contents include the contents of the lesson plan 702, the award points associated with the lesson plan 703, the number of unique downloads 704, the rating and feedback for the lesson plan 705 and the name of the author that created and uploaded the lesson plan 706. This process is used by the browse lesson plans menu 311 and the manage lesson plans menu 310. Upon completion of the preview process, the flow returns to the element from which it was called 707, either to the browse lesson plans menu 311, or to the manage lesson plans menu 310.

In the examples that follow, the educational material posted on the ABL website is, by way of example, a lesson plan.

Consider an example where user Andrew creates and uploads a lesson plan on the ABL website. User Brad downloads and reviews the lesson plan, and accrues award points. In one embodiment of the invention, user Andrews receives award points for creating and uploading the lesson plan. In another embodiment of the invention, when user Brad downloads the lesson plan, user Andrew receives more award points for the download. If additional users download the lesson plan, user Andrew will receive more award points as the reward for creating a well thought out and popular lesson plan. If user Brad downloads the lesson plan only to preview the lesson plan, in one embodiment of the invention, Brad receives no award points.

Consider an example where user Stan goes to the ABL website and logs in. Thereafter, upon being taken to the main menu, Stan selects the browse lesson plans option 311 and searches for lesson plans appropriate to the school curriculum. Stan then previews lesson plans 408 and downloads some lesson plans 512 to read at a later point in time and possibly use in a class. Stan accrues award points for downloading the lesson plan uploaded on the ABL website and in one embodiment of the invention also receives points for previewing the lesson plans. In one embodiment of the invention, the user that uploaded the lesson plan on the ABL website accrues award points when the user uploaded the lesson plan, and receives additional points when Stan downloaded the lesson plan.

Consider another example where a user logs into the ABL website and goes to the manage lesson plans menu 310. The user creates a new lesson plan 401, edits some existing lesson plans 403, and uploads those lesson plans 412 for other users to download. The user then goes to the award center menu 212 to check the award points that the user has accrued. If the user has accumulated sufficient award points by downloading lesson plans, he or she can now redeem the accrued award points for an item 615 posted on the ABL database. The user searches the ABL database for items 608 and browses the results. The user then orders the items that he or she desires.

Consider another example where user Brian accesses the ABL website and goes to the manage lesson plans menu 310. User Brian had uploaded some lesson plans 412 the previous week, and is now checking for feedback 511 other users have left on the ABL website regarding those lesson plans. Some users have made suggestions on how the lesson plan may be improved, so Brian edits the lesson plan 403 accordingly and uploads the revised version 412 of the lesson plan on the ABL website. In one embodiment of the invention, the users leaving the feedback will receive award points; and, Brian who edited and thereafter uploaded the revised lesson plan will also receive award points. Also, if the feedback that users left was positive, user Brian who uploaded the lesson plan will receive award points.

Consider another example where user Berj has just completed a class, using a lesson plan on the ABL website. Berj accesses the ABL website and browses lesson plans menu 211. Berj then downloads a lesson plan and provides feedback on improving the lesson plan 511. Berj also rates the lesson plan 518 so that other users can assess the quality of the lesson plan. In one embodiment of the invention, Berj will receive award points for providing feedback on the lesson plan; if the feedback provided by Berj was positive, the user that uploaded the lesson plan will also receive award points.

Consider another example where user Ashley logs into ABL website and browses lesson plans 211. Ashley only previews lesson plans 408 to obtain ideas for her own lessons. Ashley does not download, comment, or rate any of the lesson plans. In one embodiment of the invention, since the level of usage of the uploaded lesson plans by Ashley is minimal, Asley will receive minimal award points. The user that uploaded the lesson plan that user Asley previewed also receives award points. Ashley still benefits from using the ABL system, but not as much as a user who uses all of the system's capabilities.

While one or more embodiments of the ABL method and system have been described herein, those skilled in the art will recognize that changes and modifications may be made thereto without departing from the spirit of the invention, and it is intended to claim all such changes and modifications that fall within the scope of the ABL method and system.

1. A method to encourage users of an internet-based teaching system to download and use educational material uploaded on the teaching system's website, said users comprising a first user and a second user, the method comprising the steps of:
uploading an educational material by the first user to the website hosted on the internet;
downloading the educational material posted on the website and performing an
activity on said material that accrue points by said second user;
allocating points for said upload and for said download activity;
awarding points to said users for performing said upload and for said download activity; and,
redeeming accrued points by the users for an item of value.

2. A method to encourage users of an internet-based teaching system to download and use educational material uploaded on the teaching system's website, said users comprising a first user and a second user, the method comprising the steps of:
uploading an educational material by the first user to the website hosted on the internet;
downloading the educational material posted on the website and performing an activity on said material that accrue points by said second user;
allocating points for said download activity;
awarding points to said users for performing said download activity; and,
redeeming accrued points by the users for an item of value.

3. The method of claim 1, wherein the upload by the first user comprises creating, editing and managing educational material; and providing feedback to users on user's inquiries and comments regarding the educational material.

4. The method of claim 1, wherein the activity performed by the second user comprises previewing, viewing, editing, rating, or commenting on the educational material uploaded on the website by the first user.

5. The method of claim 1 wherein the item of value is posted on the website.

6. The method of claim 1 wherein the educational material is a lesson.

7. The method of claim 1, wherein points are awarded to a user for if it is the user's first login and download activity of a lesson plan on any given day.

8. The method of claim 1, wherein the user can choose to view the educational material of any user.

9. The method of claim 1, wherein the uploaded educational material, current award points of the user, and points associated with an item is displayed on the teaching system website.

10. The method of claim 1, wherein the user can download the most popular educational material, where the most popular educational material is one with the highest award points.

11. The method of claim 1 wherein points are awarded to the second user for previewing, viewing, editing, rating, commenting on, or critiquing the educational material uploaded on the website by the first user

12. The method of claim 11, wherein the comments by the second user is stored in a server.

13. The method of claim 1, wherein the author of the educational material posted on the website receives award points for obtaining a rank higher than a daily threshold.

14. The method of claim 1, wherein the first user accrues award points for positive feedback provided by the second user.

15. The method of claim 1, wherein the first user accrues award points when the educational material uploaded by the first user is downloaded by the second user.

16. The method of claim 1 wherein the points awarded for an upload or download activity may be increased, decreased, or reduced to zero.

17. The method of claim 3 wherein points are awarded to the first user for providing feedback to users on user's inquiry regarding the uploaded educational material.

18. A system for awarding points in an internet-based teaching system to a plurality of users comprising:
a server with multiple databases, wherein one or more of said databases maintains main user account information, information on points awarded to users and information on awards and point values associated with said awards;
client computers connected to said server; and
a website hosted on the internet and in communication with the server unit which allows said users to create, manage, upload and download said educational material.
